(19) United States
(12) Patent Application Publication
(10) Pub. No.: US 2021/0019738 A1
(43) Pub. Date: Jan. 21, 2021

(54) SYSTEMS AND METHODS FOR PERFORMING A FOREIGN EXCHANGE TRANSACTION

(71) Applicant: Wells Fargo Bank, N.A., San Francisco, CA (US)

(72) Inventors: Kristin K. Koppelman, Bloomington, MN (US); Carine P. Gursky, San Francisco, CA (US); Naga Adapala, Pleasanton, CA (US); Gregg R. Napoli, San Francisco, CA (US); Sushil Kumar Vyas, Waxhaw, NC (US)

(21) Appl. No.: 15/017,251

(22) Filed: Feb. 5, 2016

(51) Int. Cl. G06Q 20/38; G06Q 20/32; G06Q 20/42

(52) U.S. Cl. CPC G06Q 20/381; G06Q 20/42; G06Q 20/3224

(57) ABSTRACT

Systems and methods to perform a foreign exchange transaction between a buyer and a seller associated with an exchange network includes a request management circuit configured to receive an exchange request comprising a requested currency amount associated with a buyer, identify one or more exchange proposals comprising a second currency amount associated with one or more sellers, and perform the foreign exchange transaction based, at least in part, on the one or more exchange proposals, wherein funds from a repository associated with the exchange request are transferred to a repository associated with the one or more exchange proposals.

### TECHNICAL FIELD

Embodiments of the present invention relate generally to foreign exchange transactions.

### BACKGROUND

The advent of user devices configured to perform transactions has revolutionized the modes by which users engage in various consumer activities. In the past, in anticipation of traveling abroad to a different country, users would typically visit a brick and mortar foreign currency exchange provider to purchase currency that would be accepted in the country the traveler planned to visit. However, the digital age has provided a new mode that may be used to optimize the user's ability to perform a foreign exchange transaction (e.g., a purchase of foreign currency) remotely and electronically. Although the ability to perform foreign transactions electronically provides a convenient way to receive information, existing electronic foreign exchange systems have various problems and difficulties.

### SUMMARY

One embodiment relates to a method for performing a foreign exchange transaction between a buyer and a seller associated with an exchange network. The method includes receiving, by a request management circuit, an exchange request comprising a requested currency amount from a buyer device associated with a buyer, identifying, by the request management circuit, an exchange proposal comprising a second currency amount associated with one or more sellers, matching, by the request management circuit, the exchange request to the one or more exchange proposals, and performing, by the request management circuit, the foreign exchange transaction based, at least in part, on the one or more exchange proposals, wherein funds from a repository associated with the exchange request are transferred to a repository associated with the one or more exchange proposals.

One embodiment relates to a computer system comprising a request management circuit. The request management circuit is configured to receive an exchange request comprising a requested currency amount associated with a buyer, identify one or more exchange proposals comprising a second currency amount associated with one or more sellers, correlate the exchange request to the one or more exchange proposals, and perform the foreign exchange transaction based, at least in part, on the one or more exchange proposals, wherein funds from a repository associated with the exchange request are transferred to a repository associated with the one or more exchange proposals.

These and other features of the implementations described herein, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a diagram of a computing system according to an example embodiment;

FIG. 2 is a flow diagram of a method of performing a foreign exchange transaction according to an example embodiment.

FIG. 3 is a flow diagram of a method of providing one or more exchange proposals to one or more user devices according to an example embodiment.

FIG. 4 is a flow diagram of a method of providing an exchange location to one or more user devices associated with the at least one of the buyer or the one or more sellers according to an example embodiment.

FIG. 5 is a flow diagram of a method of providing the exchange notification to one or more user devices according to an example embodiment.

### DETAILED DESCRIPTION

Referring to the Figures generally, systems, apparatuses, and methods for performing a foreign exchange transaction (e.g., the exchange of a first currency for a second currency) between a buyer and a seller associated with an exchange network (e.g., an open market place for foreign exchange) are described herein. According to the present disclosure, a financial institution may facilitate the performance of a foreign exchange transaction between a buyer and a seller associated with an exchange network. The financial institution computing system may receive an exchange request (e.g., a request or ask for a particular currency) including a requested currency amount (e.g., an amount or value corresponding to the requested currency) associated with a buyer. To that end, the financial institution computing system may identify one or more exchange proposals (e.g., an offer, bid, etc. to provide currency to a buyer for an exchanged value (e.g., a fee or other consideration)) comprising one or more second currency amounts (e.g., a value corresponding to the offer or bid associated with the exchange proposal) associated with one or more sellers. The identification of the one or more exchange proposals based, at least in part, on preference criteria associated with at least one of the exchange request (e.g., the exchange request of the buyer) or the one or more exchange proposals (e.g., the exchange proposals of the sellers). The financial institution computing system then may correlate the exchange request to the one or more exchange proposals. In turn, the financial institution computing system may perform the foreign exchange transaction based, at least in part, on the one or more exchange proposals to transfer funds between the matched buyers and sellers.

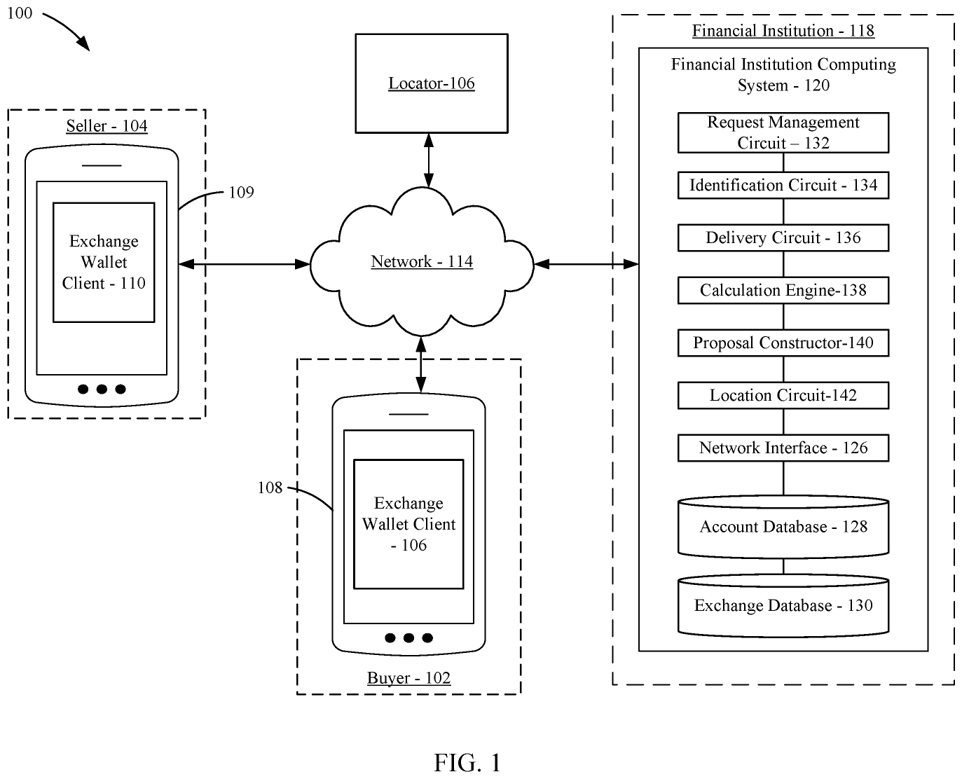

Referring to FIG. 1, a diagram of a computing system 100 is illustrated according to an example embodiment. As shown, the computing system 100 includes a locator 106, buyer device 108, seller device 109, network 114, and a financial institution 118 comprising a financial institution computing system 120. As used herein, the terms “buyer device” and “seller device” should be understood to refer to a mobile phone (e.g., a smartphone), wearable device (e.g., a smartwatch, smart eyewear, etc.), tablet computing system, laptop, personal digital assistant, or any other like device configured for communication with the financial institution computing system 118 via a network (e.g., the network 114). The financial institution computing system 120 includes a network interface 126, account database 128, exchange database 130, request management circuit 132, identification circuit 134, delivery circuit 136, calculation engine 138, proposal constructor 140, and location circuit 142. In some arrangements, the request management circuit 132 may be communicably and operatively coupled to the identification circuit 134, which is communicably and operatively coupled to the delivery circuit 136. In other arrangements, each circuit 132-142 may be communicably and operatively coupled to each other circuit 132-142.

The network interface 126 facilitates the sending and receiving of data over the network 114 (e.g., to and from the buyer device 108, the seller device 109, the financial institution computing system 120, the locator 106, etc.). As used herein, the term “network” may include any combination of local area networks, wide area networks, personal area networks, and/or the Internet. Communication of data through the network 114 may be facilitated through different types of wired and wireless network connections, including Bluetooth®, Z-Wave®, ZigBee®, Wireless (e.g., WiFi®), USB, Ethernet, mobile networks (e.g., GSM, CDMA, LTE, etc.), or other communications networks. The account database 128 stores user information and account information relating to accounts held with the financial institution 118. The exchange database 130 stores data relating to foreign exchange transactions or otherwise data corresponding to one or more consumer accounts as provided via the account database 128.

As described in further detail below, the computing system 100 facilitates the provision of a foreign exchange transaction between a buyer 102 and a seller 104 associated with an exchange network. The term “foreign exchange transaction” includes a purchase of a first currency (e.g., a fiat currency for a country in which the buyer may be traveling to) by the buyer 102 from the seller 104. In some arrangements, the buyer 102 may pay the seller 104 via a second currency (e.g., a fiat currency, a math-based currency, etc.). For example, the buyer 102 may pay the seller 104 via a fiat currency, such as the Euro, United States dollar, Canadian dollar, Indian rupee, Chinese yuan, Japanese yen, British pound, etc. In further examples, the buyer 102 may pay the seller 104 via a math-based currency, such as Bitcoin, Litecoin, Ripple, etc. The purchase may be an in-person purchase (e.g., a transaction in which the buyer 102 and the seller 104 are physically present at a location to engage in a foreign transaction) or not-present purchase (e.g., a transaction in which the buyer 102 and the seller 104 are not simultaneously present at the same location to engage in the foreign exchange transaction). In some arrangements, the seller 104 engages in the foreign exchange transaction via a certified proposal (e.g., a certified offer) in which the buyer's and/or seller's funds are held by a third-party (e.g., by the buyer or seller depositing funds with the financial institution 118 through an ATM associated with the financial institution 118) until the foreign exchange transaction is agreed upon by both parties. In such arrangements, the funds can be released to the buyer/seller after the financial institution 118 is informed of the agreed transaction. In other arrangements, to effect the payment for the purchase, the buyer 102 utilizes an exchange wallet client 106 running on a user device (e.g., the buyer device 108) to send an agreed upon amount of currency from a repository associated with the buyer 102 to a repository associated with the seller 104 as described herein below.

The financial institution computing system 120 includes the request management circuit 132. The request management circuit 132 includes at least one processor and memory as described herein below. The memory stores program instructions that, when executed via the processor, control the operation of the request management circuit 132. To begin the foreign exchange transaction, the request management circuit 132 may be configured to receive an exchange request comprising a requested currency amount associated with a buyer. As used herein, the term “exchange request” may include a request (e.g., an ask for a first currency) entered by a buyer to purchase currency (e.g., a second currency such as money, funds, legal tender, bills, coins, notes, cryptocurrency, etc.) from a seller. In some embodiments, the first currency is a fiat currency. Alternatively or additionally, the first currency is a math-based currency, such as for example, Bitcoin. Yet, in further arrangements, the exchange request may include a request (e.g., an ask for a second currency) entered by a seller to sell a first currency such as when the seller returns from Europe and requests to sell remaining currency (e.g., Euros).

The exchange request includes a requested currency amount of the first currency. As used herein the term “requested currency amount” is a requested value of the first currency associated with the exchange request. For example, the exchange request may include a requested currency amount of 10,000 Euros. To that end, the buyer 102 may provide an exchange request (e.g, an ask) to the exchange network (e.g., the market place) to receive one or more exchange proposals (e.g., one or more offers) to purchase 10,000 Euros. In some embodiments, the exchange request may be provided (e.g., posted) to the exchange network, via the network 114.

In some arrangements, the request management circuit 132 is configured to identify, via an identification circuit 134, one or more exchange proposals that satisfy the exchange request. As used herein the term “exchange proposal” may include an offer, bid, etc. to provide currency (e.g., Euros) to a buyer for an exchanged value (e.g., a fee or other consideration). In some embodiments, the one or more exchange proposals may comprise one or more second currency amounts associated with one or more sellers. As used herein, the term “second currency amount” may include a value corresponding to the offer or bid associated with the exchange proposal. The second currency amount may include a value equal to or proportional to the requested currency amount of the first currency corresponding to the exchange request. For example, the financial institution computing system 120 may identify one or more exchange proposals (e.g., offers to sell Euros) comprising second currency amounts of 8,500 Euros, 9,500 Euros, and 10,000 Euros in response to an exchange request seeking Euros.

In some embodiments, the exchange proposal may be identified based, at least in part, on preference criteria. As used herein the term “preference criteria” may include at least one of a currency type, currency amount, exchange rate, exchange value, settlement type, preference constraint, geographic location, etc. For example, the exchange proposal identified may be based on the currency (e.g., Euro), currency amount (e.g., 10,000 Euros), exchange rate (e.g., 0.29), settlement type (e.g., ATM), and geographic location (e.g., Frankfurt, Germany).

In some example arrangements, the preference criteria may be associated with at least one of the exchange request or the one or more exchange proposals. To that end, the identification circuit 134 may be configured to receive preference criteria. The preference criteria may be received via an exchange wallet client 106, 110 (e.g., an application associated with the buyer device 108, the seller device 109, or any other user device configured to receive and/or provide data corresponding to a foreign exchange), website, etc., associated with at least one of one or more buyer devices 108 or one or more seller devices 109. In some embodiments, the preference criteria is stored and/or retrieved, via memory or one or more databases (e.g., the account database 128 or the exchange database 130). In such arrangements, the identification circuit 134 is configured to receive or otherwise retrieve the preference criteria associated with the exchange request.

Alternatively or additionally, the identification circuit 134 may be configured to compare the preference criteria associated with the exchange request to the preference criteria associated with the one or more exchange proposals. For example, the preference criteria associated with the exchange request for a requested currency amount of 10,000 Euros may include the preference criteria “currency” (e.g., Euro), “requested currency amount” (e.g., 10,000 Euros), “settlement type” (e.g., ATM), “exchange rate” (e.g., 0.25) of Euros to Dollars, “preference constraint” (e.g., a minimum currency amount of 8,500 Euros and/or a maximum currency amount 10,500 Euros), and “geographic location” (e.g., Frankfurt, Germany). The preference criteria associated with the one or more exchange proposals may include the preference criteria “currency” (e.g., Euro), “second currency amount” (e.g., 8,000 Euros, 9,500 Euros, and 10,000 Euros), “settlement type” (e.g., ATM), “exchange rate” (e.g., 0.24), and “geographic location” (e.g., Frankfurt Germany).

In this regard, the identification circuit 134 is configured to identify the one or more exchange proposals based, at least in part, on the preference criteria in response to the compared preference criteria associated with the exchange request and the preference criteria associated with the one or more exchange proposals. The identification circuit 134 identifies matching exchange proposals from the exchange database 130 that meet the criteria of the buyer's exchange request as defined by the preference criteria. Accordingly, the identification circuit 134 may identify one or more exchange proposals comprising a second currency amount of at least 8,500 Euros and less than 10,500 Euros to meet the buyer's preference constraint. From the above-referenced exchange proposals, the identification circuit 134 may identify exchange proposals comprising the “second currency amount” (e.g., 9,500 Euros, and 10,000 Euros) as potential proposals (e.g., offers or bids) to provide to the buyer 102.

In some embodiments, the identification circuit 134 is configured to analyze the one or more exchange proposals (e.g., offers, bids, etc.) to determine the probabilities (e.g., the probability that a buyer would accept each of the respective exchange proposals), that a buyer 102 would accept a particular exchange proposal. The probabilities that a buyer 102 would accept a particular exchange proposal may be calculated via a calculation engine 138. The calculation engine 138 may be configured to generate or otherwise determine the probabilities based, at least in part, on previous acceptance history of buyers provided via an account database 128, interest (e.g., demand) for similar exchange proposals provided via the exchange database 130, current trends in the exchange network (e.g., a market place), survey results, etc. The calculation engine 138 may provide the probabilities to the identification circuit 134. Using the probabilities a forecasted proposal interest (e.g., forecasted demand) may be generated via the identification circuit 134.

In some example embodiments, the financial institution computing system 120 includes a proposal constructor 140. The proposal constructor 140 is configured to adjust one or more exchange proposals to increase the likelihood that a buyer will accept a seller's exchange proposal. In some example embodiments, the proposal constructor 140 may be configured to adjust one or more exchange proposals based on at least one of preference criteria (e.g., currency amount, exchange rate, etc.), probabilities, proposal availability (e.g. the supply of offers in the market place), previous acceptance history provided via the account database 128, interest for similar exchange proposals provided via the exchange database 130, current trends in the exchange network (e.g., a market place), survey results, etc. In this regard, bounds may be provided for acceptable second currency amounts, requested currency amounts, etc. The one or more exchange proposals may be adjusted at the time of the proposal submission from the seller, after the system identifies a potential match that is unlikely to accept the originally submitted exchange proposal, after the exchange proposal has been sitting and not accepted for a predetermined period of time, etc. In turn, the one or more exchange proposals comprising the adjustments may be provided to the request management circuit 132. Alternatively or additionally, the one or more exchange proposals may be provided to the delivery circuit 136 as described herein.

In some embodiments, the financial institution computing system 120 includes the delivery circuit 136. The delivery circuit 136 is configured to provide a user interface for interacting with the exchange network to at least one user device 108,109. In this regard, the delivery circuit 136 is configured to provide the one or more exchange proposals to one or more buyer devices 108 associated with one or more buyers 102. Alternatively or additionally, the delivery circuit 136 may be configured to provide the one or more exchange proposals to one or more seller devices 109 associated with one or more sellers 104. The delivery circuit 136 may include, or otherwise be operable via, at least one of a display, a web user interface, a mobile application, other client device, etc. For example, the one or more exchange proposals may be output, via a display, to the buyer device 108 and/or the seller device 109. In further embodiments, the one or more exchange proposals may be output, via a mobile application (e.g., the exchange wallet client 106, 110), to the buyer device 108 and/or the seller device 109. Yet, in other example embodiments, the one or more exchange proposals may be output, via a web user interface corresponding to the financial institution computing system 120, to the buyer device 108 and/or the seller device 109.

In some arrangements, the request management circuit 132 is further configured to rank the one or more exchange proposals to indicate that a particular exchange proposal may be ranked higher, lower, or equal to other respective exchange proposals. The one or more exchange proposals may be ranked according to at least one of preference criteria, probabilities, proposal availability, previous acceptance history, interest for similar exchange proposals, current trends in the exchange network (e.g., a marketplace), survey results, etc. The one or more exchange proposals may be ranked higher, lower, or equal to other respective exchange proposals. For example, the one or more exchange proposals may be ranked according to the preference criteria (e.g. the second currency amount offered, exchange rate, and geographic location) associated with the one or more exchange proposals that best match the preference criteria associated with the exchange request. In this regard, an exchange proposal including the second currency amount that matches or is equal to the requested currency amount may be ranked higher than an exchange proposal that includes a second currency amount including a value different from the requested currency amount. In another example, the one or more exchange proposals may be ranked according to interest (e.g., demand provided by survey results) in the exchange network (e.g., a market place). Yet, in further embodiments, the one or more exchange proposals may be ranked according to the determined probabilities that the buyer 102 would accept each respective exchange proposal. The request management circuit 132 may be configured to provide the ranked one or more exchange proposals to the delivery circuit 136 for output, via the buyer device 108 and/or the seller device 109, to a user (e.g., the buyer and/or the seller).

The request management circuit 132 is configured to generate an exchange notification. As used herein, the term “exchange notification” may include at least one of a digital form, popup, text message, instant message, audio message, email, mobile message, or exchange network message. An exchange notification is generated to communicate a suggested exchange request (e.g., a suggested request or ask to purchase currency), suggested exchange proposal (e.g., suggested offer based on the adjustments made to the exchange proposal), an expired exchange proposal (e.g., a stale offer), expired request (e.g., a stale request to purchase currency), etc.

In further embodiments, the exchange notification is configured to communicate a suggested exchange proposal and/or a suggested exchange request to increase the success of performing the foreign exchange transaction (e.g., the exchange of a first currency for a second currency). The suggested exchange request and/or the suggested exchange proposal may be based on the one or more exchange proposals and/or one or more exchange requests adjusted via the proposal constructor as described above. For example, the suggested exchange proposal may include a message stating “Other sellers like you increased their success of their offer being accepted by offering 10,000 Euros at an exchange rate of 0.11%.” Yet, in some examples, the exchange notification is configured to communicate an expired request and/or an expired proposal to prompt the buyer 102 and/or the seller 104 to update the corresponding exchange request and/or exchange proposal. In turn, the request management circuit 132 may be configured to provide the exchange notification to one or more user devices associated with the at least one of the buyer 102 or the seller 104. The exchange notification may be provided to or otherwise received by the delivery circuit 136.

In some embodiments, the request management circuit 132 is configured to receive one or more updates to at least one of the exchange request or the one or more exchange proposals. In this regard, the request management circuit 132 is configured to update at least one of the exchange request or the one or more exchange proposals. In some embodiments, the exchange notification may include a digital form configured to receive input (e.g., updates, changes, etc. of the preference criteria) to, in turn, update respective data corresponding to at least one of the one or more exchange requests or the one or more exchange proposals. For example, the seller 104 may update the second currency amount offered and/or the exchange rate via the exchange notification. In other example embodiments, the exchange notification may include a link, an icon, an image, a button, etc. configured to receive user input (e.g., updates, changes, etc. of the preference criteria) or otherwise indicate an update to at least one of the one or more exchange requests or the one or more exchange proposals.

In some embodiments, the request management circuit 132 is configured to correlate (e.g., match), via the processor, the exchange request to the one or more exchange proposals. Accordingly, the correlation of the exchange request to the one or more exchange proposals may include receiving an indication of selection of one or more exchange proposals. The request management circuit 132 may receive, via the delivery circuit 136, an indication of selection in response to the selection of a link, an icon, an image, a button, a list (e.g., a list of exchange promotions, a dropdown list, etc.), checkbox, other input type, etc. Alternatively or additionally, the request management circuit 132 may receive an indication of selection in response to the receipt of an audible selection received via a user device. In some embodiments, the delivery circuit 136 may receive an indication of selection of a single exchange proposal. For example, a buyer 102 may select, via a mobile application comprising a button, a single exchange proposal. In other embodiments, the delivery circuit 136 may receive an indication of selection of a plurality of exchange proposals. For example, a buyer 102 may select, via a user interface comprising a plurality of checkboxes, a plurality of exchange proposals. To that end, in some embodiments, the one or more exchange proposals may be configured to be accepted or rejected via the delivery circuit 136. In turn, the delivery circuit 136 may provide, via request management circuit 132, the indication of selection to the financial institution computing system 120.

In some embodiments, the request management circuit 132 is configured to perform, via the processor, the foreign exchange transaction (e.g., the exchange of a first currency for a second currency) based, at least in part, on the one or more exchange proposals. For example, the foreign exchange transaction may be performed based on the selection of one or more exchange proposals. In this regard, funds from a repository (e.g., an account associated with the buyer 102) associated with the exchange request are transferred to or otherwise provided to a repository (e.g., an account associated with the seller 104) associated with the one or more exchange proposals.

Alternatively or additionally, the request management circuit 132 may be configured to receive user rating data. As used herein, the term “user rating data” may include data corresponding to the buyer 102 and/or the seller 104 to indicate whether the respective buyer 102 and/or seller 104 experienced a satisfactory foreign exchange transaction. For example, the request management circuit 132 may receive user rating data (e.g., feedback) from a buyer 102 in regards to whether the buyer 102 experienced a satisfactory foreign exchange transaction. The user rating data may be provided to the calculation engine 138 to determine a user score. In some embodiments, the calculation engine 138 may aggregate each respective user to score to determine an aggregated user score.

In further embodiments, a buyer 102 and/or a seller 104 may receive a transaction penalty in response to a respective user score failing to meet a pre-determined threshold. For example, a user may receive a transaction penalty in response to receiving a user score below the pre-determined threshold for failing to complete the foreign exchange transaction. In some embodiments, the user score and/or the aggregated user score is output, via the delivery circuit 136, to the exchange network (e.g., the market place).

In some embodiments, the financial institution computing system 120 may include a location circuit 142 configured to generate an exchange location (e.g., a location where the currency may be exchanged). The exchange location may be generated, via the location circuit 142 associated with a locator 106 and/or the network 114. The locator 106 may include a system configured for multilateration, global positioning system (GPS), and/or other locating system configured to obtain the position of a user device (e.g., the buyer device 108, the seller device 109, etc.) and, in some embodiments, a user associated with the user device. The user device may include a transmitter and/or a receiver. In some example embodiments, the user device may include a transceiver configured to operate as a transmitter and receiver. The transmitter and the receiver may be operable to, respectively, send and/or receive signals (e.g., signal data corresponding to an air interface standard associated with a communication system (e.g., cellular system), speech data, received data, etc.).

In further embodiments, the location circuit 142 is configured to receive, via the locator 106, a geographic location associated with at least one of the buyer 102 (e.g., as provided via the buyer device 108) or the one or more sellers 104 (e.g., as provided via the seller device 109). Responsive to receiving the geographic location provided via each respective user device 108, 109, the location circuit 142 may be configured to determine a distance between the respective geographic locations associated with the buyer 102 or the one or more sellers 104.

In some arrangements, the location circuit 142 generates the exchange location based at least in part on a location of the buyer 102, a location of the seller 104, and the buyer and seller preferences. The exchange location may be generated based on the shortest distance between the buyer 102 and the one or more sellers 104. In some examples, the exchange location may be generated according to the geographic location of the buyer 102 in relation to the nearest financial institution. Alternatively or additionally, the exchange location may be generated according to the geographic location of the seller 104 in relation to the nearest financial institution. For example, the exchange location may be generated according to the geographic location of the buyer 102 and/or the seller 104 in relation to the nearest bank, ATM, etc.

The location circuit 142 may be configured to provide the exchange location to one or more user devices 108, 109 associated with at least one of the buyer 102 or the one or more sellers 104. To that end, the location circuit 142 may provide the exchange location to the delivery circuit 136 for provision (e.g., via a mobile application, user interface, etc.) to the user device 108, 109 as described herein above. In some embodiments, the delivery circuit 136 may be configured to retrieve or otherwise receive the exchange location. In some embodiments, a plurality of exchange locations may be generated and/or provided to one or more user devices 108,109 to provide options for the buyer 102 to receive the currency. Alternatively or additionally, a plurality of exchange locations may be generated and/or provided to one or more user devices 108,109 to provide options for the seller 104 to input the currency.

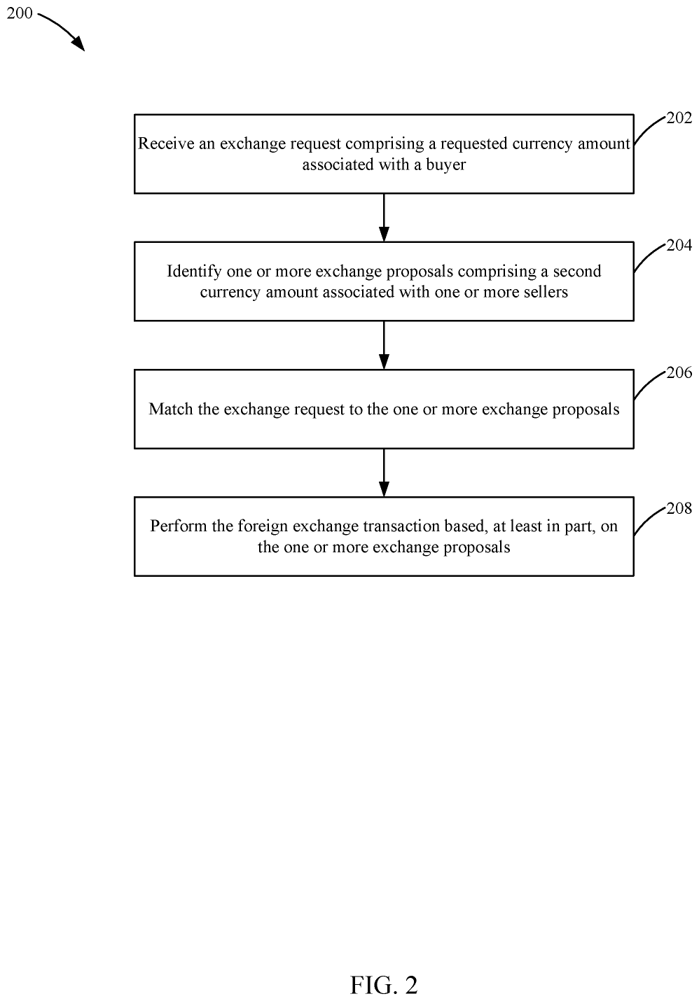

With reference to FIG. 2, a flow diagram of a method 200 of performing a foreign exchange transaction is shown according to an example embodiment. Method 200 is performed by the financial institution computing system 120. For example, the method 200 is performed by the various components of the financial institution computing system 120, such as the request management circuit 132, the identification circuit 134, and the delivery circuit 136. The method 200 begins when an exchange request comprising a requested currency amount associated with a buyer is received at 202. The request management circuit 132 of the financial institution computing system 120 receives the exchange request from the buyer device 108 via the network 114. The exchange request may be entered by a buyer 102 to purchase a first currency from a seller in exchange for a second currency. The exchange request includes a requested currency amount of the first currency. In some arrangements, the exchange request is provided (e.g., posted) to an exchange network (e.g., a market place) maintained by the financial institution computing system 120.

In some embodiments, one or more exchange proposals comprising one or more second currency amounts associated with one or more sellers are identified at 204. The request management circuit 132 of the financial institution computing system 120 identifies the one or more exchange proposals. The one or more exchange proposals are identified based, at least in part, on preference criteria associated with at least one of the exchange request or the one or more exchange proposals. In some embodiments, the one or more exchange proposals may comprise one or more second currency amounts associated with one or more sellers. The second currency amount may include a value equal to or proportional to the requested currency amount corresponding to the exchange request. The preference criteria may include at least one of a currency, currency amount, exchange rate, exchange value, settlement type, preference constraint, geographic location, etc. In some example embodiments, the preference criteria may be associated with at least one of the exchange request or the one or more exchange proposals.

In some embodiments, the exchange request is correlated (e.g., matched) by the request management circuit 132, to the one or more exchange proposals at 206. In this regard, the correlation of the exchange request to the one or more exchange proposals may include receiving an indication of selection of one or more exchange proposals in response to the selection of a link, an icon, an image, a button, a list, checkbox, other input type, etc. Alternatively or additionally, the request management circuit 132 may receive an indication of selection in response to the receipt of an audible selection received via a user device. In turn, the delivery circuit 136 may provide, via request management circuit 132, the indication of selection to the financial institution computing system 120.

In some embodiments, the foreign exchange transaction is performed, by the request management circuit 132, based, at least in part, on the one or more exchange proposals at 208. Accordingly, funds from a repository associated with the buyer 102 are transferred to or otherwise provided to one or more repositories associated with one or more sellers 104. The transfer of payment may be effected via the exchange wallet client 106 corresponding to the buyer device 108. For example, the buyer 102 may utilize the exchange wallet client 106 running on the buyer's device 108 to send an agreed upon amount of currency from a repository associated with the buyer 102 to a repository associated with the seller 104.

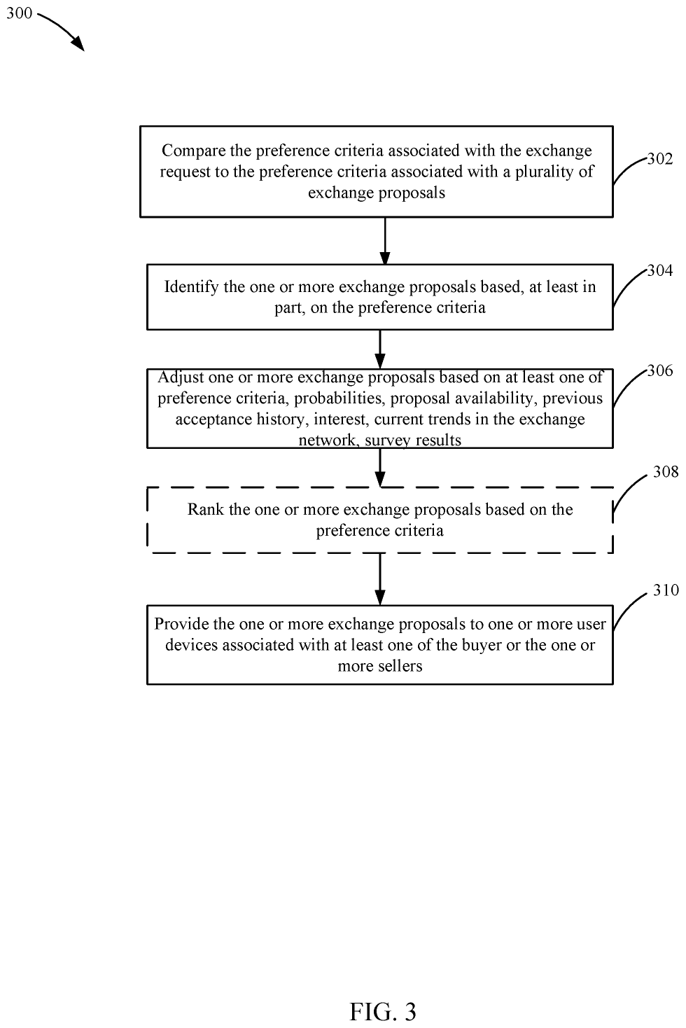

With respect to FIG. 3, a flow diagram of a method 300 of providing one or more exchange proposals to one or more user devices is shown according to an example embodiment. Method 300 may be performed by the request management circuit 132, identification circuit 134, delivery circuit 136, calculation engine 138, and proposal constructor 140 of the financial institution computing system 120. The method 300 begins when the preference criteria associated with the exchange request is compared, by the identification circuit 134, to the preference criteria associated with a plurality of exchange proposals at 302. For example, the buyer 102 may submit an exchange request for a requested currency amount of 20,000 Euros. The preference criteria may include “currency” (e.g., Euro), “requested currency amount” (e.g., 20,000 Euros), “settlement type” (e.g., ATM), “exchange rate” (e.g., 0.15) of Euros to Dollars, “preference constraint” (e.g., a minimum currency amount of 15,000 Euros and/or a maximum currency amount 20,500 Euros), and “geographic location” (e.g., Frankfurt, Germany). Three sellers may submit an exchange proposal (e.g., an offer) including second currency amounts of 9,000 Euros, 15,500 Euros, and 20,000 Euros respectively. The preference criteria associated with each respective exchange proposal may include the preference criteria “currency” (e.g., Euro), “second currency amount” (e.g., 9,000 Euros, 15,500 Euros, and 20,000 Euros), “settlement type” (e.g., ATM), “exchange rate” (e.g., 0.16), and “geographic location” (e.g., Frankfurt Germany). In turn, one or more exchange proposals of the plurality of exchange proposals are identified based, at least in part, on the preference criteria in response to the compared preference criteria associated with the exchange request and the preference criteria associated with the one or more exchange proposals at 304.

In some embodiment, the method 300 may proceed to 306. At 306, one or more exchange proposals are adjusted, by the proposal constructor 140, based on at least one of preference criteria, probabilities, proposal availability (e.g. the supply of offers in the market place), previous acceptance history, interest for similar exchange proposals, current trends in the exchange network (e.g., a market place), or survey results. The proposal constructor 140 adjusts the one or more exchange proposals to increase the likelihood that a buyer will accept a seller's exchange proposal. The one or more exchange proposals may be adjusted after the system identifies a potential match that is unlikely to accept the originally submitted exchange proposal. In turn, the one or more exchange proposals comprising the adjustments may be provided to the request management circuit 132.

In further embodiments, one or more exchange proposals are ranked, by the request management circuit 132, based on the preference criteria at 308. The ranked one or more exchange proposals indicate that a particular exchange proposal may be ranked higher, lower, or equal to other respective exchange proposals. The one or more exchange proposals may be ranked according to at least one of preference criteria, probabilities, proposal availability, previous acceptance history, interest for similar exchange proposals, current trends in the exchange network (e.g., a marketplace), survey results, etc. The one or more exchange proposals may be ranked higher, lower, or equal to other respective exchange proposals. Accordingly, an exchange proposal including a second currency amount that matches or is equal to the requested currency amount may be ranked higher than an exchange proposal that includes a second currency amount including a value different from the requested currency amount. The ranked one or more exchange proposals may be provided to the delivery circuit 136 for output, via the buyer device 108 and/or the seller device 109, to a user at 310.

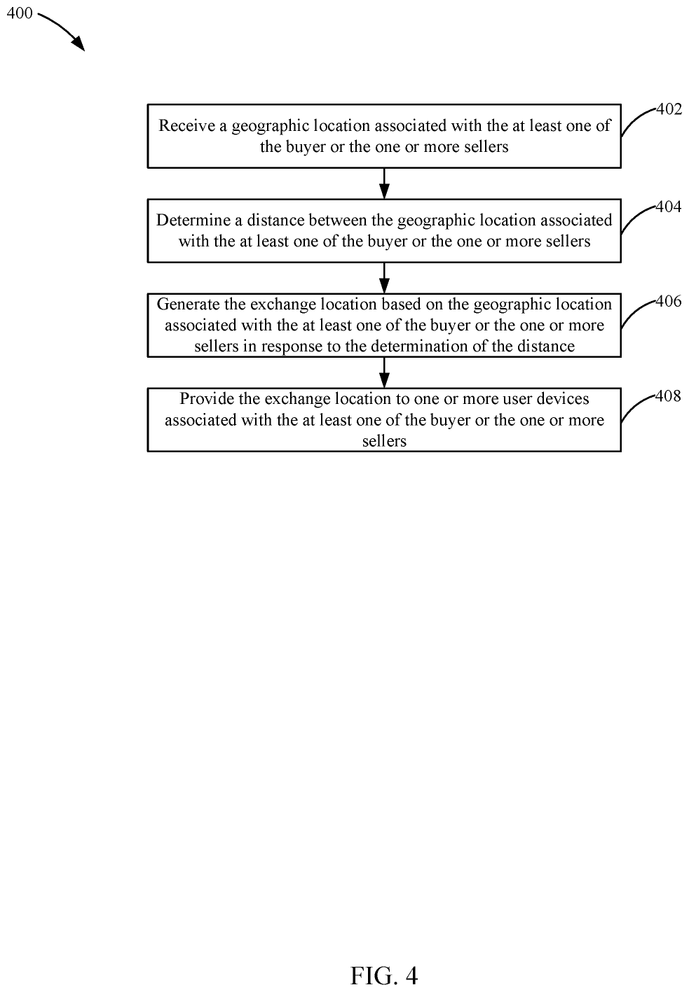

With respect to FIG. 4, a flow diagram of a method 400 of providing an exchange location to one or more user devices associated with the at least one of the buyer or the one or more sellers is shown according to an example embodiment. Method 400 may be performed by the request management circuit 132, delivery circuit 136, and location circuit 142. The method 400 begins when a geographic location associated with at least one of the buyer or the one or more sellers is received, by the request management circuit 132, at 402. In turn, the method 400 may proceed to 404 at which point a distance between the respective geographic locations associated with the buyer or the one or more sellers is determined.

In some example embodiments, the exchange location is generated, by the request management circuit 132, based on the geographic location associated with at least one of the buyer or the one or more sellers responsive to the determination of the distance between the respective geographic locations associated with the buyer or the one or more sellers at 406. To that end, the exchange location may be generated based on the shortest distance between the buyer and the one or more sellers. Alternatively or additionally, the exchange location may be generated according to the geographic location of the buyer in relation to the nearest settlement type (e.g., financial institution, bank, ATM).

In further example embodiments, the exchange location is provided to one or more user devices associated with at least one of the buyer or the one or more sellers at 408. Accordingly, the exchange location may be provided to the delivery circuit 136 for provision, via the exchange wallet client (e.g., a mobile application), user interface, etc., to respective user devices as described herein with reference to FIG. 1. In some embodiments, a plurality of exchange locations may be generated and/or provided to one or more user devices to provide options for the buyer to receive the currency. Alternatively or additionally, a plurality of exchange locations may be generated and/or provided to one or more user devices to provide options for the seller input the currency.

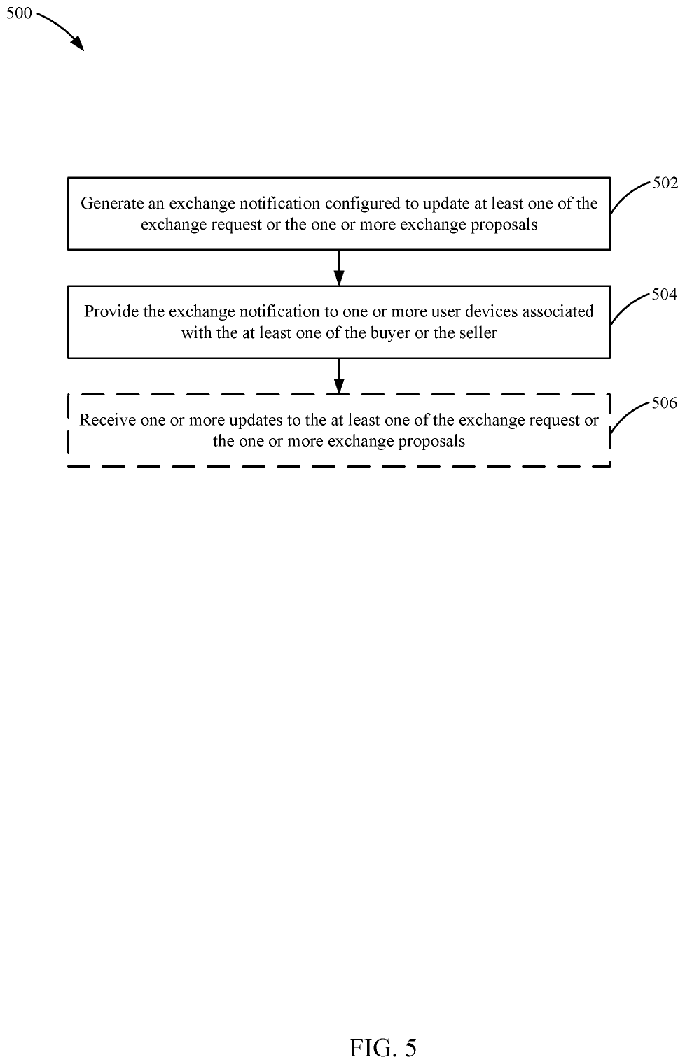

With respect to FIG. 5, a flow diagram of a method 500 of providing an exchange notification to one or more user devices is shown according to an example embodiment. Method 500 is performed by the request management circuit 132 and/or the delivery circuit 136. The method 500 begins when an exchange notification (e.g., a digital form, popup, text message, instant message, audio message, email, mobile message, etc.) is generated, by the request management circuit 132, at 502. In some embodiments, the one or more exchange proposals may comprise the exchange notification. Alternatively or additionally, the exchange notification may be generated independent of the one or more exchange proposals. In further embodiments, the exchange notification may be configured to communicate a suggested exchange proposal (e.g., suggested offer based on the adjustments made to the exchange proposal). Alternatively or additionally, the exchange notification may be configured to communicate a suggested exchange request (e.g., a suggested request or ask) to increase the success of performing the foreign exchange transaction. In turn, the method 500 may proceed to provide the exchange notification to one or more user devices associated with the at least one of the buyer or the seller at 504.

In further example embodiments, one or more updates to the at least one of the exchange request or the one or more exchange proposals are received, by the request management circuit 132, at 506. Accordingly, the exchange notification may be configured to update at least one of the exchange request or the one or more exchange proposals. In some embodiments, the exchange notification may include a digital form configured to receive input. In turn, one or more updates to the at least one of the exchange request or the one or more exchange proposals are received. In other example embodiments, the exchange notification may include a link, a button, etc. configured to indicate an update to at least one of the one or more exchange requests or the one or more exchange proposals.

As described herein a buyer and seller have the ability to engage in a foreign exchange transaction (e.g., a purchase of foreign currency) remotely and electronically. However, existing electronic foreign exchange systems have various problems and difficulties such as limiting the buyer's flexibility to choose from multiple exchange proposals (e.g., offers), failing to identify exchange proposals that may be of interest to the buyer, etc. Accordingly, the systems, method, and apparatus described herein provides users with the ability to perform foreign transactions electronically via a user device to obtain foreign currency efficiently within a peer network, choose between multiple exchange proposals (e.g., offers) identified as exchange proposals the user may find of interest, conveniently submit an exchange request eliminating the need to travel to brick and mortar locations during designated business hours, etc.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A method comprising:
receiving, by a request management circuit, an exchange request from a buyer device associated with a buyer, the exchange request including a currency amount requested by the buyer;
receiving, by the request management circuit, via the buyer device, preference criteria associated with the exchange request;
identifying, by the request management circuit, one or more exchange proposals associated with one or more sellers, each exchange proposal including a currency amount offered by a seller, wherein identifying the one or more exchange proposals comprises:
determining, by the request management circuit, an amount that each of the one or more exchange proposals matches the preference criteria,
automatically ranking, by the request management circuit, the one or more exchange proposals based, at least in part, on the amount that each of the one or more exchange proposals matches the preference criteria, and
providing, by the request management circuit, the ranked one or more exchange proposals to the buyer device;
determining, by the request management circuit, a suggested update to the exchange request to increase a likelihood of the exchange proposal being accepted by at least one seller, the suggested update based on at least one of the preference criteria associated with the exchange request, a probability of acceptance, a proposal availability, a previous acceptance history, an interest, or a current trend in the exchange network;
generating, by the request management circuit, an exchange notification including the suggested update to the exchange request;
in response to receiving input from the buyer, updating, by the request management circuit, the exchange request based on the suggested update;
matching, by the request management circuit, the updated exchange request to at least one exchange proposal; and
performing, by the request management circuit, a foreign exchange transaction based, at least in part, on the at least one exchange proposal, wherein performing the foreign exchange transaction comprises transferring funds from a repository associated with the buyer to a repository associated with one of the one or more sellers.

2. The method of claim 1, wherein determining the amount that each of the one or more exchange proposals matches the preference criteria comprises:
comparing the preference criteria associated with the exchange request to preference criteria associated with each of the one or more exchange proposals.

3. (canceled)

4. (canceled)

5. The method of claim 1, wherein receiving the exchange request comprises receiving the exchange request via an exchange network and identifying the one or more exchange proposals comprises identifying the one or more exchange proposals via the exchange network;
wherein the method further comprises providing a user interface for interacting with the exchange network to at least one user device associated with at least one of the buyer or the one or more sellers.

6. The method of claim 1, wherein matching the updated exchange request to the at least one exchange proposal comprises:
receiving an indication of selection of the at least one exchange proposal by the buyer.

7. The method of claim 1, wherein the offered currency amount comprises at least a portion of the requested currency amount.

8. The method of claim 2, wherein each of the preference criteria associated with the exchange request and the preference criteria associated with each of the one or more exchange proposals comprises at least one of a currency, currency amount, settlement type, or geographic location.

9. The method of claim 1, wherein the method further comprises generating an exchange location, and wherein the generation of the exchange location comprises:
receiving a geographic location associated with the buyer and at least one of the one or more sellers;
determining a distance between the geographic location associated with the buyer and the at least one of the one or more sellers;
generating the exchange location in response to the determination of the distance; and
providing the exchange location to one or more user devices associated with at least one of the buyer or the one or more sellers.

10. The method of claim 1, wherein the method further comprises:
generating a second exchange notification, wherein the second exchange notification is configured to update an exchange proposal from the one or more exchange proposals; and
providing the second exchange notification to a user device associated with the seller associated with the exchange proposal.

11. The method of claim 1, further comprising:
receiving one or more updates to the exchange request via the exchange notification.

12. The method of claim 10, wherein the exchange notification and the second exchange notification each comprises at least one of a digital form, text message, instant message, audio message, email, mobile message, or exchange network message.

13. (canceled)

14. A computer system comprising:
a request management circuit, the request management circuit configured to:
receive an exchange request associated with a buyer, the exchange request including a currency amount requested by the buyer;
receive, via a buyer device associated with the buyer, preference criteria associated with the exchange request;
identify one or more exchange proposals associated with one or more sellers, each exchange proposal including a currency amount offered by a seller, the identification comprising:
determining an amount that each of the one or more exchange proposals matches the preference criteria,
automatically ranking the one or more exchange proposals based, at least in part, on the amount that each of the one or more exchange proposals matches the preference criteria, and
providing the ranked one or more exchange proposals to the buyer device;
determine a suggested update to the exchange request to increase a likelihood of the exchange proposal being accepted by at least one seller, the suggested update based on at least one of the preference criteria associated with the exchange request, a probability of acceptance, a proposal availability, a previous acceptance history, an interest, or a current trend in the exchange network;
generate an exchange notification including the suggested update to the exchange request;
in response to receiving input from the buyer, update the exchange request based on the suggested update;
match the updated exchange request to at least one exchange proposal; and
perform a foreign exchange transaction based, at least in part, on the at least one exchange proposal, wherein funds from a repository associated with the buyer are transferred to a repository associated with one of the one or more sellers.

15. The computer system of claim 14, wherein the computer system further comprises:
an identification circuit, the identification circuit configured to:
compare the preference criteria associated with the exchange request to preference criteria associated with each of the one or more exchange proposals.

16. (canceled)

17. (canceled)

18. The computer system of claim 14, wherein the request management circuit is configured to receive the exchange request and identify the one or more exchange proposals via an exchange network; and
wherein the computer system further comprises a delivery circuit configured to provide a user interface for interacting with the exchange network to at least one user device associated with the buyer or the one or more sellers.

19. The computer system of claim 14, wherein the request management circuit is further configured to match the updated exchange request to the at least one exchange proposal by:
receiving an indication of selection of the at least one exchange proposal by the buyer.

20. The computer system of claim 14, wherein the offered currency amount comprises at least a portion of the requested currency amount.

21. The computer system of claim 15, wherein each of the preference criteria associated with the exchange request and the preference criteria associated with each of the one or more exchange proposals comprises at least one of a currency, currency amount, settlement type, or geographic location.

22. The computer system of claim 14, wherein the computer system further comprises:
a location circuit configured to generate an exchange location, and wherein the generation of the exchange location comprises:
receiving a geographic location associated with the buyer and at least one of the one or more sellers;
determining a distance between the geographic location associated with the buyer and the at least one of the one or more sellers;
generating the exchange location in response to the determination of the distance; and
providing the exchange location to one or more user devices associated with at least one of the buyer or the one or more sellers.

23. The computer system of claim 14, wherein the request management circuit is further configured to:
generate a second exchange notification, wherein the second exchange notification is configured to update an exchange proposal from the one or more exchange proposals; and
provide the second exchange notification to a user device associated with the seller associated with the exchange proposal.

24. The computer system of claim 14, wherein the request management circuit is further configured to receive one or more updates to the exchange request via the exchange notification.

25. The computer system of claim 23, wherein the exchange notification and the second exchange notification each comprises at least one of a digital form, text message, instant message, audio message, email, mobile message, or exchange network message.

26. (canceled)

27. A method comprising:
receiving, by a request management circuit, an exchange request from a buyer device associated with a buyer, the exchange request including a currency amount requested by the buyer;
receiving, by the request management circuit, via the buyer device, preference criteria associated with the exchange request;
identifying, by the request management circuit, one or more exchange proposals associated with one or more sellers, each exchange proposal including a currency amount offered by a seller, wherein identifying the one or more exchange proposals comprises:
determining, by the request management circuit, an amount that each of the one or more exchange proposals matches the preference criteria,
automatically ranking, by the request management circuit, the one or more exchange proposals based, at least in part, on the amount that each of the one or more exchange proposals matches the preference criteria, and
providing, by the request management circuit, the ranked one or more exchange proposals to the buyer device;
determining, by the request management circuit, a suggested update to a first exchange proposal from the one or more exchange proposals to increase a likelihood of the first exchange proposal being accepted by the buyer, the suggested update based on at least one of the preference criteria associated with the exchange request, a probability of acceptance, a proposal availability, a previous acceptance history, an interest, or a current trend in the exchange network;
generating, by the request management circuit, an exchange notification including the suggested update to the first exchange proposal;
in response to receiving input from the seller associated with the first exchange proposal, updating, by the request management circuit, the first exchange proposal based on the suggested update;
matching, by the request management circuit, the exchange request to at least one exchange proposal; and
performing, by the request management circuit, a foreign exchange transaction based, at least in part, on the at least one exchange proposal, wherein performing the foreign exchange transaction comprises transferring funds from a repository associated with the buyer to a repository associated with one of the one or more sellers.

28. The method of claim 27, wherein the at least one exchange proposal comprises the updated first exchange proposal.

29. The method of claim 27, wherein determining the amount that each of the one or more exchange proposals matches the preference criteria comprises:
comparing the preference criteria associated with the exchange request to preference criteria associated with each of the one or more exchange proposals.

30. (canceled)

31. The method of claim 27, further comprising:
receiving one or more updates to the first exchange proposal via the exchange notification.
